(19) United States
(12) Patent Application Publication
(10) Pub. No.: US 2007/0228616 A1
(43) Pub. Date: Oct. 4, 2007

(54) DEVICE AND METHOD FOR CUTTING NONMETALIC SUBSTRATE

(76) Inventor: Kyu-Yong Bang, GUMI-CITY (KR)

Correspondence Address: KED & ASSOCIATES, LLP, P.O. Box 221200, Chantilly, VA, 20153-1200, US

(21) Appl. No.: 11/596,121

(22) PCT Filed: May 11, 2005
(86) PCT No.: PCT/KR05/01375

§ 371 Date: Nov. 9, 2006

(51) Int. Cl. B29C 35/08

(52) U.S. Cl. 264/405

(57) ABSTRACT

An apparatus for cutting a nonmetallic substrate (P) and method thereof are disclosed. The present invention is suitable for cutting upper and lower substrates (P) simultaneously or for cutting either an upper or lower substrate selectively in a manner of controlling a cutting depth by adjusting a focus position of a short wavelength laser beam in cutting various nonmetallic substrates (P) such as a glass substrate for fabricating a flat panel display such as TFT-LCD, PDP, OLED, etc. The present invention includes a laser beam generator (10) generating a UV short wavelength laser beam, a torch (6) applying the short wavelength laser beam to a specific location on the nonmetallic substrate to be cut, a focus moving means (8) for varying a focus location of the laser beam in a depth direction of the substrate, and a relative object moving means (3, 4) for allowing the substrate and the laser beam to make a relative movement to cut the substrate.

### TECHNICAL FIELD

The present invention relates to an apparatus for cutting a nonmetallic substrate and method thereof. Although the present invention is suitable for a wide scope of applications, it is particularly suitable for cutting upper and lower substrates simultaneously or for cutting either an upper or lower substrate selectively in a manner of controlling a cutting depth by adjusting a focus position of a short wavelength laser beam in cutting various nonmetallic substrates such as a glass substrate for fabricating a flat panel display such as TFT-LCD, PDP, OLED, etc.

### BACKGROUND ART

Generally, in fabricating such a flat panel display device as TFT-LCD, PDP, OLED and the like, it is necessary to cut a glass substrate to fit each module size after completion of a boding process of a cell process. And, it is also necessary to selectively cut a glass of an upper plate only in a bonded substrate.

As a glass cutting method according to a related art, there is a cutting method using a mechanical instrument such as a diamond wheel. In this case, a cutting depth of a glass is decided by a primary crack generated from a direct impact of a wheel and a secondary crack generated from a further progress of the primary crack. Since the generated primary and secondary cracks differ from each other in size, the cutting depth fails to be uniform so that a cutting face of a substrate is not precise.

As another cutting method according to a related art, there is a CO₂ laser cutting method, which consists of the steps of forming a primary microcrack at a point where a scribe line starts using a wheel as a mechanical means, heating a glass using a heating beam of CO₂ laser secondarily, and then cooling down the heated portion of the glass fast using a quencher to induce a secondary crack due to instant thermal transformation.

In the above cutting method, since it is unable to precisely control a cutting depth of the glass, a cutting face of the glass fails to be precise.

In the above-explained two kinds of the cutting methods, an instrument for the laser cutting method using the CO₂ laser according to a related art is schematically explained as follows.

First of all, a laser cutter according to a related art consists of a support or table supporting a glass substrate to be cut, an auxiliary cracker forming an auxiliary crack coinciding with a cutting direction of the substrate, an optical heating system heating the substrate by applying a heating beam to the substrate along a scribe line, and a quencher generating a crack by quenching the portion heated by the optical heating system.

Glass cutting using the related art laser cutter consists of an auxiliary crack forming step using a wheel, a heating step according to the auxiliary crack, a cutting-crack forming step through quick-freeze using a quencher moving in the same direction to spray refrigerants such as He, a re-irradiation step of a scribe laser beam, and a re-quenching step.

A detailed configuration and operation of the related art laser cutter are described in Korean Patent Application Laid-Open No. 2002-88258.

However, the above-explained related art cutting method, which allows a single plate to be cut, needs cutting devices provided to both upper and lower sides of the substrate to simultaneously upper and lower plates of the bonded panel.

Namely, in case of the related art cutting method using the mechanical means such as a diamond wheel, one wheel cuts one single plate only. Hence, in order to simultaneously cut the upper and lower plates of the bonded panel, exclusive wheels should be provided to upper and lower parts, respectively. And, support rollers supporting the exclusive wheels should be provided to support upper and lower surfaces of the bonded panel, respectively. Moreover, a breaking device is needed to separate the cutting face. Hence, the system configuration of the cutter is complicated, whereby the related art method and system are not facilitated to use.

Specifically, in the related art mechanical cutting device provided with the wheels at the upper and lower parts of the bonded panel, the upper and lower exclusive wheels should be accurately aligned to perform the cutting work. So, a correction step for the coincidence of the alignment between the upper and lower exclusive wheels should be accompanied. In case of correction failure occurrence, the cutting faces are misaligned to degrade a product quality.

In case of the cutting method using the CO₂ laser, the CO₂ laser, auxiliary cracker, quencher and the like should be provided over and under the bonded panel, whereby the overall system configuration is complicated to lower productivity.

And, in case of the cutting method using the CO₂ laser, since the CO₂ lasers provided over and under the bonded panel, respectively need to precisely aligned to perform the cutting work, an alignment correction for the upper and lower exclusive wheels is needed. In case of correction failure occurrence, the cutting faces are misaligned to degrade a product quality.

Specifically, the above cutting methods are unable to control the cutting depth of the glass accurately, whereby precision of the cutting face is considerably lowered.

### DISCLOSURE OF THE INVENTION

Accordingly, the present invention is directed to an apparatus for cutting a nonmetallic substrate and method thereof that substantially obviate one or more of the problems due to limitations and disadvantages of the related art.

An object of the present invention is to provide an apparatus for cutting a nonmetallic substrate and method thereof, by which simultaneous cutting of upper and lower substrates or selective cutting of either an upper or lower substrate is enabled in a manner of controlling a cutting depth by adjusting a focus position of a short wavelength laser beam in cutting various nonmetallic substrates such as a glass substrate for fabricating a flat panel display such as TFT-LCD, PDP, OLED, etc.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, an apparatus for cutting a nonmetallic substrate according to the present invention includes a laser beam generator generating a UV short wavelength laser beam, a torch applying the short wavelength laser beam to a specific location on the nonmetallic substrate to be cut, a focus moving means for varying a focus location of the laser beam in a depth direction of the substrate, and a relative object moving means for allowing the substrate and the laser beam to make a relative movement to cut the substrate.

To further achieve these and other advantages and in accordance with the purpose of the present invention, an apparatus for cutting a nonmetallic substrate includes a laser beam generator generating a UV short wavelength laser beam, a torch applying the short wavelength laser beam to a specific location on the nonmetallic substrate to be cut, a laser displacement sensor measuring a distance between the torch and the substrate and a relative distance between the substrate and the laser beam, a focus moving means for varying a focus location of the laser beam in a depth direction of the substrate and for varying a height to the torch from the substrate to correspond to the measured relative distance to maintain a cutting depth uniform in cutting, and a relative object moving means for allowing the substrate and the laser beam to make a relative movement to cut the substrate.

To further achieve these and other advantages and in accordance with the purpose of the present invention, a method of cutting a nonmetallic substrate includes the steps of providing a UV short wavelength laser beam, setting up a focus location of the laser beam in a depth direction of the substrate, a distance between a laser beam torch and a main substrate surface, and moving the focus location of the laser beam based on the distance to the main substrate surface and set focus location data.

To further achieve these and other advantages and in accordance with the purpose of the present invention, a method of cutting a nonmetallic substrate includes the steps of providing a UV short wavelength laser beam, providing a variable focus lens enabling a focus variation of the laser beam, setting up a focus location of the laser beam in a depth direction of the substrate, measuring a distance between a laser beam torch and a main substrate surface, and moving the focus location of the laser beam to the setup focus location based on the distance to the main substrate surface and set focus location data.

To further achieve these and other advantages and in accordance with the purpose of the present invention, a method of cutting a nonmetallic substrate includes the steps of mounting the nonmetallic substrate on a table to be fixed thereto, providing a UV short wavelength laser beam, setting a focus location of the laser beam in a depth direction of the substrate to a specific value, measuring a distance between a laser bean torch and a main substrate surface, correcting a relative disposition between the substrate and the laser beam by moving a real focus location of the laser beam to coincide with the preset focus location based on the distance to the main substrate surface and set focus location data, applying the UV short wavelength laser beam to a predetermined location on the substrate via the torch, and moving the substrate and the laser beam relatively to cut the substrate into a specific form.

Therefore, the present invention controls a specific cutting depth precisely by adjusting a focus position of a short wavelength laser beam in cutting various nonmetallic substrates such as a glass substrate for fabricating a flat panel display such as TFT-LCD, PDP, OLED, etc. Specifically, the present invention enables simultaneous cutting of upper and lower substrates of a bonded panel (P) or selective cutting of either an upper or lower substrate in fabricating a display module.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective diagram of an apparatus for cutting a nonmetallic substrate according to one embodiment of the present invention;

FIG. 2A and FIG. 2B are a diagram and flowchart of a laser beam focus controller and method in an apparatus for cutting a nonmetallic substrate according to a first embodiment of the present invention;

FIG. 3A and FIG. 3B are a diagram and flowchart of a laser beam focus controller and method in an apparatus for cutting a nonmetallic substrate according to a second embodiment of the present invention;

FIG. 4A and FIG. 4B are a diagram and flowchart of a laser beam focus controller and method in an apparatus for cutting a nonmetallic substrate according to a third embodiment of the present invention; and

FIG. 5A and FIG. 5B are diagrams for explaining a substantial application of an apparatus for cutting a nonmetallic substrate according to the present invention, in which FIG. 5A shows a case of cutting upper and lower surfaces of a bonded panel simultaneously and in which FIG. 5B shows a step-difference cutting of cutting either a upper or lower surface of a bonded panel.

### BEST MODE FOR CARRYING OUT THE INVENTION

Reference will now be made in detail to the preferred embodiments of the present invention, examples of which are illustrated in the accompanying drawings.

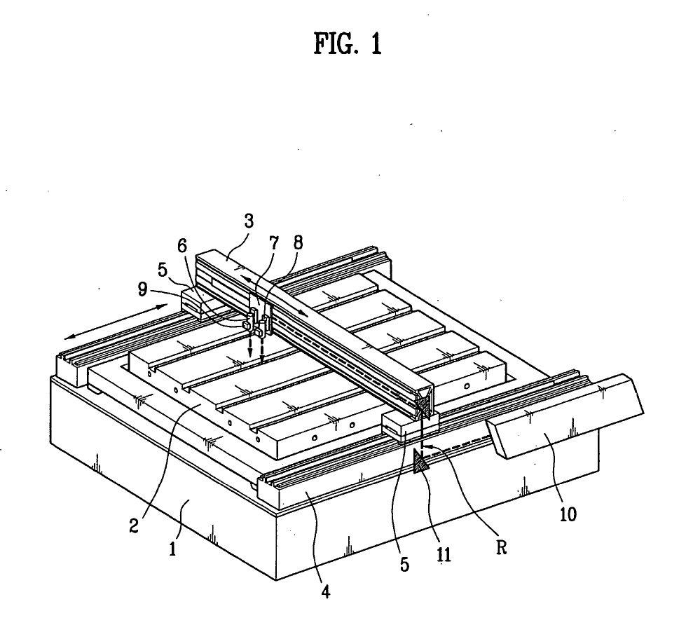

FIG. 1 is a perspective diagram of an apparatus for cutting a substrate for fabricating a flat panel display device according to one embodiment of the present invention.

Referring to FIG. 1, an apparatus for cutting a substrate for fabricating a flat panel display device according to one embodiment of the present invention includes a table 2 provided to a central part of a base 1 to support a glass substrate (not shown in the drawing), back-and-forth guide columns 4 provided to both sides of the table 2, respectively, and a linear motor & mover 5 provided to each of the back-and-forth guide column 4.

A right-to-left guide column 3 is provided to each of the movers 5 to guide a movement of a torch 6 in right-to-left directions. And, a linear motor & mover separate from the former linear motor & mover 5 provided on the back-and-forth guide column 4 is provided to the right-to-left guide column 3.

A torch mount block 7 is mounted on the mover on the right-to-left guide column 3 so that the torch 6 can be mounted on the mover. And, the torch 6, which condenses a UV short wavelength laser beam to apply to a prescribed area of the glass substrate, is mounted on the torch mount block 7.

And, the substrate cutting apparatus according to the present invention includes an optical system 11 guiding a laser beam toward the torch 6 and a laser beam generator 10 generating the UV short wavelength layer beam.

Moreover, the substrate cutting apparatus according to the embodiment of the present invention includes an instrumentation means 9 for measuring a relative distance between the substrate and a focus of the laser beam and a distance between the torch 6 and a main substrate surface, i.e., an upper surface of the substrate).

The instrumentation means 9 includes a non-contact type displacement sensor, and more preferably, a laser displacement sensor (not shown in the drawing) provided to a front end of a cutting laser bean to irradiate a laser beam.

And, an LED sensor as a photosensor, an ultrasonic sensor or the like can be used as the non-contact type displacement sensor.

In adjusting a focus to be positioned at a cutting depth of the substrate prior to cutting, the substrate cutting apparatus according to the present invention is provided with a focus moving means 8 for aligning a focus position with the cutting depth by varying the focus position of the laser beam in a substrate depth direction.

In this case, in order to keep the cutting depth uniform in cutting the substrate, the focus moving means 8 is also operative in varying a height to the torch 6 from the substrate to correspond to the measured relative distance between the focus of the laser beam and the main substrate surface.

And, the laser beam focus moving means 8 can include a step motor (not shown in the drawing) as a drive source, a ball screw shaft (not shown in the drawing) assembled to the step motor, and a ball screw block (not shown in the drawing) joined to the ball screw shaft to have the torch 6 attached thereto.

Alternatively, the laser beam focus moving means 8 may include a linear motor and a mover assembled to the linear motor to move up and down and to have the torch 6 attached thereto.

Alternatively, the laser beam focus moving means 8 may include a piezoelectric element assembled to the torch 6. If a predetermined voltage is applied to the piezoelectric element, the piezoelectric element is mechanically transformed to move a position of the torch 6.

Meanwhile, the focus movement of the laser beam can be implemented by optical adjustment instead of the mechanical position adjustment. So, a variable focus lens 8a provided within the torch 6 is operative as the laser beam focus moving means.

In this case, unlike the case of controlling the focus position by varying the distance between the torch and the substrate without changing a focus distance, the cutting depth is controllable without changing the distance between the torch 6 and the substrate in a manner of varying the focus distance by a distance adjustment between lenses configuring the variable focus lens 8a.

Meanwhile, at least two torches 6 are preferably provided to enhance a cutting speed. Hence, there is one method using two laser oscillating devices to make the laser beam incident on the torches, respectively. And, there is another method using two torches with a path diverting device (mirror). In this case, the path diverting device allows a laser beam, which is generated from one laser oscillating device, to be selectively incident on each of the torches if necessary.

Alternatively, another cutting method, in which a laser generated from one laser oscillating device is split by a spectroscope to be applied to each of the two torches, is applicable. In this case, energy of the split laser may be reduced. Yet, if energy sufficient for cutting is secured, this method is applicable despite the split beam.

In the above-explained configuration, the substrate put on the table 2 is cut by the relative movement of the torch 6 due to the driving device including the motor, the ball screw and the like and the guide device and by the applied UV short wavelength laser beam. Yet, a configuration of a relative object moving means. for cutting the substrate by allowing the substrate and the laser beam to make relative movements mutually is not limited to the above-explained example.

Alternatively, unlike the former configuration, when the table 2 is guided to move back-and-forth and right-to-left directions by the driven motor, the UV short wavelength laser beam is applied via the torch to perform the glass substrate cutting work. Alternatively, both of the substrate and the torch 6 are moved to perform the cutting work as well.

Meanwhile, the laser beam generator 10 includes a laser oscillator of Nd-YAG medium, a laser diode providing a exciting light source to the laser oscillator, and a wavelength converter converting a wavelength of a laser beam generated from the laser oscillator to a short wavelength.

The laser beam having a long wavelength coming through the Nd-YAG medium is converted to a UV short wavelength of 200˜400 nm via crystal operative in wavelength conversion.

Meanwhile, a frequency of the laser beam lies between 1˜100 KHz.

Specifically, a frequency of the laser beam is at least 10 KHz and preferably lies between 10˜30 KHz. It is a matter of course that the frequency of the laser beam can be at least 30 KHz or higher according to a corresponding situation.

For reference, YAG corresponds to Yttrium, Aluminum and Garnet used in manufacturing an oscillator for leaser beam generation. Nd (neodymium: atomic No. 60, atomic weight 144.2) is added to YAG to form Nd-YAG. A process of cutting a glass substrate in a flat panel display device using the above-configured substrate cutting apparatus according to the present invention is explained as follows.

First of all, in fabricating a display device such as TFT-LCD, PDP, OLED and the like, a process of cutting bonded substrates (hereinafter called bonded panel) is carried out after the substrates have been bonded together.

The substrate includes a plurality of unit cells on a disc type glass substrate and needs to be cut into a plurality of the unit cells.

And, to control display information of the substrate, a TAB is attached to a specific surface of the substrate. In this case, a single plate of the bonded panel (P) including a pair of the substrates bonded together needs to be cut only.

For this, the glass substrate is loaded from outside on a mountable table 2 by a carrier robot and the like.

The substrate put on the table 2 is horizontally fixed thereto by support pins (not shown in the drawing) provided within the table 2 or a multitude of vacuum holes formed at the table 2 to be stably supported thereon.

Subsequently, a relative position between the substrate and a laser beam to be applied thereto is corrected so that the substrate fixed to the table 2 can be cut into a specific form.

In correcting the relative position, an image recognizer (e.g., vision camera) recognizes a correction mark formed on the substrate to confirm a location thereof and the torch 6 from which the laser beam is irradiated is then relatively moved against the table 2 to correct the relative position.

In the location conformation of the laser beam, a test laser beam is applied to a dummy glass to form. a laser beam trace thereon and the laser beam trace is then grasped using the image recognizer such as a vision camera or a location of the torch 6 from which the laser beam is irradiated is then recognized using the image recognizer provided under the torch 6.

Meanwhile, after the relative position between the substrate and the laser beam has been corrected, the substrate and the laser beam are relatively moved to cut the substrate into a specific shape.

Namely, the laser beam generated from the laser oscillator using Nd-YAG as a medium is provided to the torch 6 as a condensing part of the laser beam via the optical system 11 to be applied to a predetermined location on the substrate. In doing so, the table 2 having the substrate mounted thereon is fixed instead of being moved, whereas the torch 6 is moved. As a result, the substrate is cut by the movement of the laser beam.

In this case, the laser beam generated from the laser oscillator uses the laser diode as a light source. The generated laser beam changes it path via the optical system 11 including a plurality of mirrors and the like to be provided to the torch 6 as a laser beam condensing part. Since the torch 6 and the mirrors of the optical system 11 that send the laser beam toward the torch 6 are moved horizontally and simultaneously, the UV short wavelength laser beam is applied to the substrate regardless of the location variation of the torch 6. Therefore, the substrate can be cut into a designed shape.

In this case, the wavelength of the light generated from the diode as the light source is provided to the Nd-YAG medium to be excited by a gain medium so that the laser of 1,000 nm can be oscillated. The oscillated laser is passed through the wavelength conversion crystal to be oscillated as the short wavelength of 200˜400 nm.

Thus, the laser is converted to the short wavelength to use. By using the UV short wavelength, this is to minimize the product breakage due to thermal transformation induced by the long wavelength when the laser beam is applied to the nonmetallic substance such as the glass substrate and the like to be cut.

Besides, to raise energy of the laser beam, Q-switching is optically performed using an optical resonator to generate an ultra-short pulse of 1˜100 nanoseconds (ns).

To raise a cutting speed, a frequency over several KHz is generated to apply the laser beam. If so, clear cutting can be achieved even if a moving speed of the torch 6 or the table 2 is high.

Meanwhile, in cutting the glass substrate substantially to cut the substrate into unit cells in the back-and-forth direction, the substrate can be cut in the back-and-forth direction in a manner that the laser beam is applied via the torch 6 while the right-to-left guide column 3 is moved in the back-and-forth direction by a guidance of the back-and-forth guide column 4 due to the action of the linear motor.

And, in cutting the glass substrate substantially to cut the substrate into unit. cells in the right-to-left direction, the substrate can be cut in the right-to-left direction in a manner that the laser beam is applied via the torch 6 while the torch mount block 7 and the torch 6 mounted on the block 7 are moved in the right-to-left direction by a guidance of the right-to-left guide column 3 due to the action of the linear motor provided to the right-to-left guide column 3.

Thus, as the UV short wavelength laser beam alternately repeats the back-and-forth and right-to-left movements so that the respective cells on the glass substrate can be separated from each other individually and completely (singulation).

Meanwhile, in cutting the glass substrate using the UV short wavelength laser beam, the cutting depth of the substrate should be accurately set up prior to a substantial cutting work.

For this, a location at which the laser beam is focused is controlled to coincide with the cutting depth of the substrate to be cut, which is explained as follows.

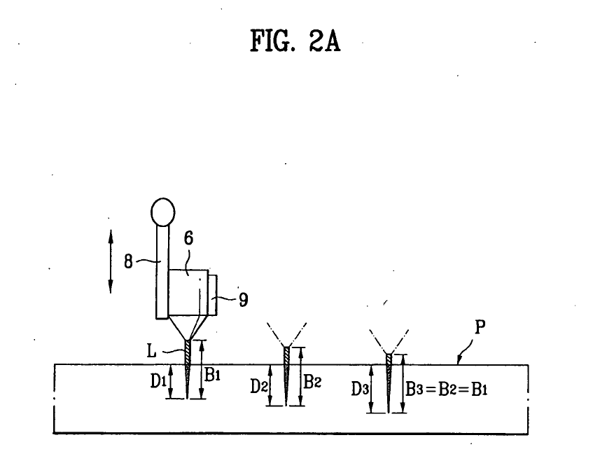

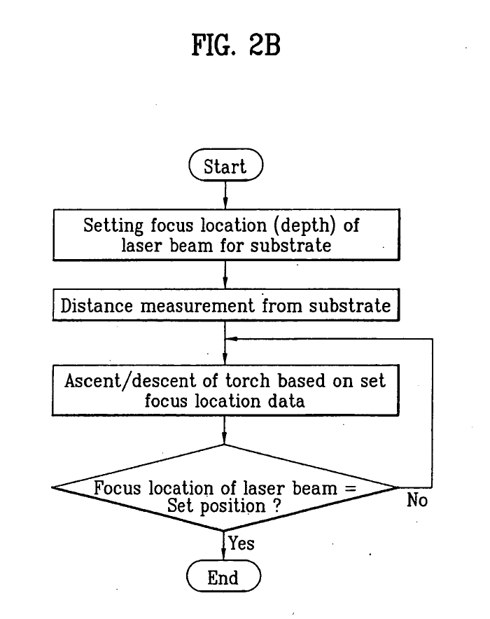

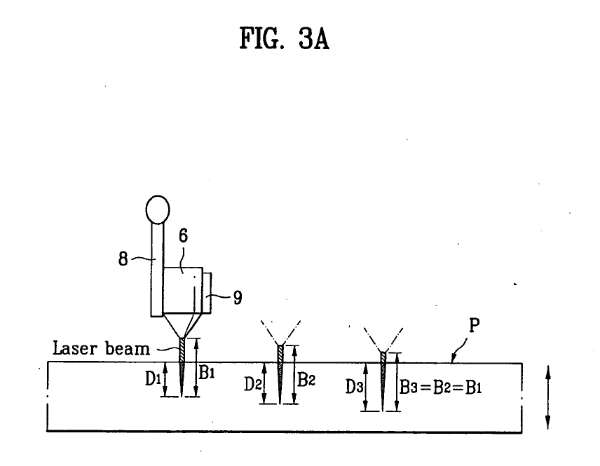

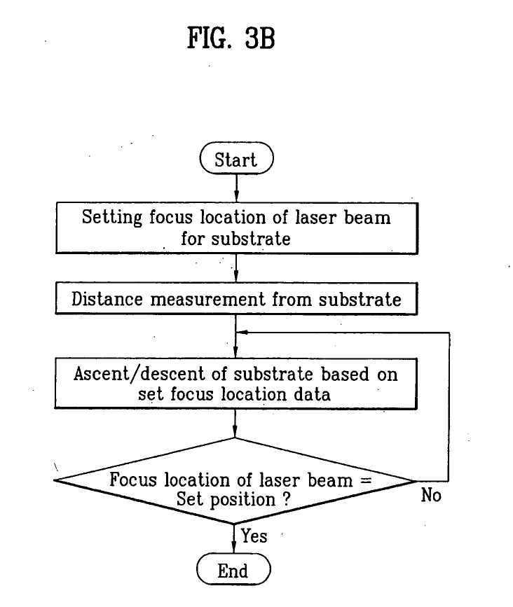

First of all, referring to FIG. 2B and FIG. 3B, a focus location of the laser beam in a substrate depth direction is set to a specific value. A measurement of distance between the laser beam torch 6 and the main substrate surface is then carried out.

Hence, based on the distance to the main substrate surface and the set focus location data, a real focus location of the laser beam is moved to coincide with the ser focus location.

In doing so, a focus location control of the laser beam, as shown in FIG. 2A and FIG. 2B, is carried out by an ascent or descent of the torch 6. Alternatively, the focus location control of the laser beam, as shown in FIG. 3A and FIG. 3B, is carried out by an ascent or descent of the substrate.

Namely, the cutting depth is decided by the focus location control of the laser beam. Hence, as the distance between the laser beam torch 6 and the main substrate surface is varied with changing the focus distance (B1,B2,B3: B1=B2=B3), the variation of the cutting depth (D1,D2,D3: D1<D2<D3) is enabled.

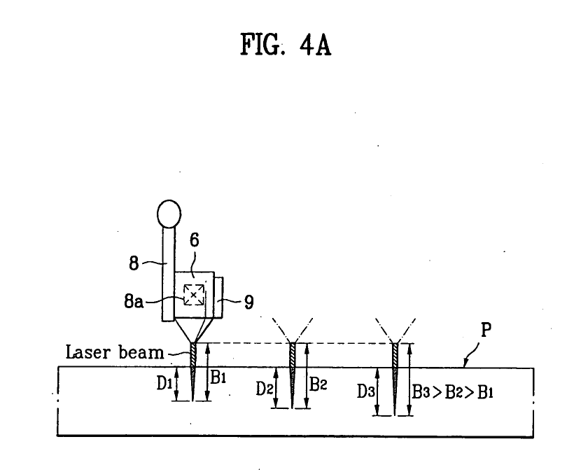

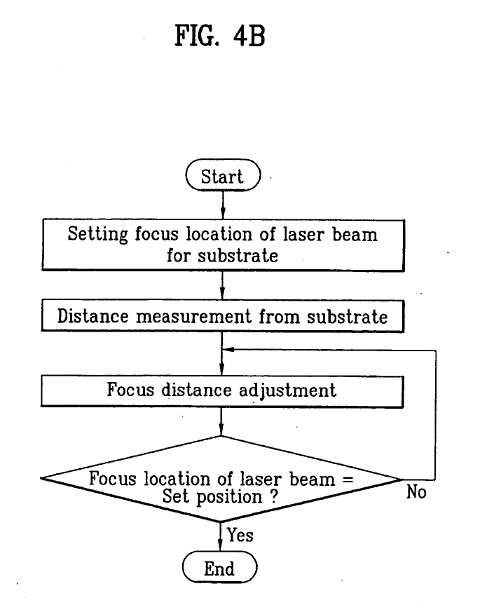

Referring to FIG. 4A and FIG. 4B, by varying the focus distance, it is able to control the cutting depth without adjusting the distance between the torch 6 and the substrate.

In this case, the focus location of the laser beam is set in the substrate depth direction and the measurement of the distance between the laser beam torch 6 and the main substrate surface is then carried out.

Subsequently, the focus location of the laser beam is moved to the set position based on the distance to the main substrate surface and the set focus location data. In doing so, by the adjustment of the variable focus lens 8a provided within the torch 6, the focus distance of the laser beam is varied (B1,B2,B3: B1<B2<B3 in FIG. 4A).

Namely, by extending or shortening the focus distance of the laser beam, it is able to control the focus location without changing the distance between the torch 6 and the substrate.

In doing so, the measurement of the distance between the laser beam torch 6 and the main substrate surface is carried out by the non-contact method using irradiation of a distance measurement laser beam, which is different the UV short wavelength laser beam for cutting, or ultrasonic wave.

As explained in the above description, the nonmetallic substrate cutting apparatus according to the present invention can implement the precise cutting of the nonmetallic substrate, thereby selectively enabling the step-difference cutting (cutting either an upper or lower substrate only) of the bonded panel (P) such as a flat panel display or the simultaneous of the upper and lower substrates of the bonded panel (P).

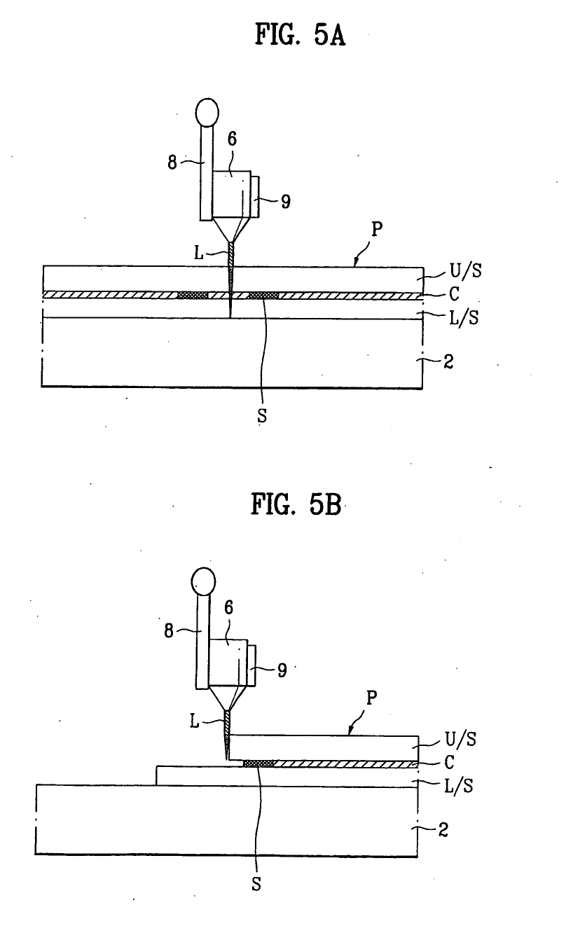

Namely, in order to divide the bonded panel (P) into unit cells by cutting the upper and lower substrates of the bonded panel (P) simultaneously, the cutting, as shown in FIG. 5A, is carried out after the focus of the laser beam is made to coincide with a bottom of the lower substrate to correspond to an overall thickness of the bonded panel (P).

In the step-difference cutting of cutting either the upper or lower substrate (e.g., upper substrate) of the bonded panel (P), the cutting, as shown in FIG. 5B, is carried out after the focus of the laser beam is made to coincide with a bottom of the upper substrate to correspond to a thickness of the upper substrate.

Q-switching optically performed to raise the energy of the laser beam and the optical resonator applied to Q-switching are explained for reference in the following.

First of all, a gain of a laser medium in a normal oscillation mode corresponds to a value barely exceeding a loss including an output drive-out component. In doing so, by increasing an inversion distribution quantity to exceed a threshold, it is able to obtain a more powerful laser beam.

Specifically, a loss of the optical resonator is raised to increase the inversion distribution quantity to exceed an oscillation threshold. Namely, a Q value is lowered.

Thus, after the Q value has been artificially lowered, if the Q value is raised when the inversion distribution quantity has a predetermined high value, a gain coefficient becomes much higher than the oscillation threshold to bring about the oscillation of the powerful laser beam. Such a technique is called Q-switching.

Meanwhile, in the optical resonator, since it is unable to make an efficient laser beam with the amplification of beam by induction discharge, parallel mirrors enabling beam resonance are used.

If the induction discharge occurs while the inversion distribution continues and if the beam is fed back to a laser medium section by the reflective mirrors, the beam is amplified. If a time for the beam to go and return between a pair of the mirrors becomes a multiple of an integer, a standing wave is generated to abruptly increase the induction discharge. And, the optical resonator has such a configuration to generate the laser beam.

### INDUSTRIAL APPLICABILITY

Accordingly, in fabricating a module of such a display as TFT-LCD, PDP, OLED and the like, the present invention can precisely adjust the cutting depth in a manner of controlling the focus location of the short-wavelength laser beam in glass cutting.

And, the present invention is applicable to any kind of nonmetallic substrates as well as the glass substrate of the flat panel display. Therefore, the present invention provides high industrial applicability.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. An apparatus for cutting a nonmetallic substrate, comprising:
a laser beam generator generating a UV short wavelength laser beam;
a torch applying the short wavelength laser beam to a specific location on the nonmetallic substrate to be cut;
a focus moving means for varying a focus location of the laser beam in a depth direction of the substrate; and
a relative object moving means for allowing the substrate and the laser beam to make a relative movement to cut the substrate.

2. The apparatus of claim 1, the laser beam generator comprising:
a laser oscillator of an Nd-YAG medium;
a laser diode providing an exciting light source to the laser oscillator; and
a wavelength converter converting a wavelength of the laser beam generated from the laser oscillator to a short wavelength.

3. The apparatus of claim 2, wherein the wavelength converter is a crystal.

4. The apparatus of claim 1, wherein a wavelength of the laser beam applied via the torch lies between 200˜400 nm.

5. The apparatus of claim 1 or claim 4, wherein a frequency of the laser beam lies between 1˜100 KHz.

6. The apparatus of claim 1, further comprising an optical resonator turning the laser beam into an ultra short pulse by performing Q-switching on the laser beam optically to allow the laser beam to have high energy.

7. The apparatus of claim 1, the laser beam focus moving means comprising:
a step motor as a drive source;
a ball screw shaft joined to the step motor; and
a ball screw block joined to the ball screw shaft to have the torch attached thereto.

8. The apparatus of claim 1, the laser beam focus moving means comprising:
a linear motor; and
a mover joined to the linear motor to ascend wherein the torch is attached to the mover.

9. The apparatus of claim 1, the laser beam focus moving means comprises a piezoelectric element joined to the torch to move a position of the torch by being mechanically transformed according to an impression of a predetermined voltage.

10. The apparatus of claim 1, wherein the laser beam focus moving means comprises a variable focus lens provided within the torch.

11. The apparatus of claim 1, further comprising an instrumentation means for measuring a distance between the torch and the substrate.

12. The apparatus of claim 1, wherein the instrumentation means comprises a laser displacement sensor provided in front of the laser beam torch to irradiate a distance measuring laser beam.

13. The apparatus of claim 1, wherein the torch comprises at least two torches differing from each other in a focus distance of the laser beam.

14. An apparatus for cutting a nonmetallic substrate, comprising:
a laser beam generator generating a UV short wavelength laser beam;
a torch applying the short wavelength laser beam to a specific location on the nonmetallic substrate to be cut;
a laser displacement sensor measuring a distance between the torch and the substrate and a relative distance between the substrate and the laser beam;
a focus moving means for varying a focus location of the laser beam in a depth direction of the substrate and for varying a height to the torch from the substrate to correspond to the measured relative distance to maintain a cutting depth uniform in cutting; and
a relative object moving means for allowing the substrate and the laser beam to make a relative movement to cut the substrate.

15. A method of cutting a nonmetallic substrate, comprising the steps of:
providing a UV short wavelength laser beam;
setting up a focus location of the laser beam in a depth direction of the substrate;
measuring a distance between a laser beam torch and a main substrate surface; and
moving the focus location of the laser beam based on the distance to the main substrate surface and set focus location data.

16. The method of claim 15, wherein the focus location of the laser beam is controlled by moving the torch.

17. The method of claim 15, wherein the focus location of the laser beam is controlled by moving the substrate.

18. The method of claim 15, wherein the distance between the laser beam torch and the main substrate surface is performed by a non-contact measurement.

19. A method of cutting a nonmetallic substrate, comprising the steps of:
providing a UV short wavelength laser beam;
providing a variable focus lens enabling a focus variation of the laser beam;
setting up a focus location of the laser beam in a depth direction of the substrate;
measuring a distance between a laser beam torch and a main substrate surface; and
moving the focus location of the laser beam to the setup focus location based on the distance to the main substrate surface and set focus location data.

20. The method of claim 19, wherein the distance between the laser beam torch and the main substrate surface is performed by a non-contact measurement.

21. The method of claim 20, wherein the distance between the laser beam torch and the main substrate surface is performed by irradiation of a distance measuring laser beam.

22. A method of cutting a nonmetallic substrate, comprising the steps of:
mounting the nonmetallic substrate on a table to be fixed thereto;
providing a UV short wavelength laser beam;
setting a focus location of the laser beam in a depth direction of the substrate to a specific value;
measuring a distance between a laser beam torch and a main substrate surface;
correcting a relative disposition between the substrate and the. laser beam by moving a real focus location of the laser beam to coincide with the preset focus location based on the distance to the main substrate surface and set focus location data;
applying the UV short wavelength laser beam to a predetermined location on the substrate via the torch; and
moving the substrate and the laser beam relatively to cut the substrate into a specific form.

23. The method of claim 22, wherein the focus location of the laser beam is performed by ascent or descent of the torch and/or the substrate.

24. The method of claim 23, wherein the focus location of the laser beam keeps being controlled whole the substrate is being cut.

25. The method of claim 22, wherein the laser beam is generated from a laser oscillator using ND-YAG as a medium to be provided to the torch as a collector of the laser beam via an optical system.

26. The method of claim 25, wherein a laser beam applied location is checked in a manner of applying a test laser beam to a dummy glass and grasping the location by recognizing a laser beam trace on the dummy glass using an image recognizer.

27. The method of claim 25, wherein a laser beam applied location is checked in a manner of applying a test laser beam to a dummy glass and recognizing a location of the torch having the laser beam applied thereto using an image recognizer provided under the torch.

28. The method of claim 20, wherein the nonmetallic substrate is a bonded panel comprising upper and lower plates.

29. The method of claim 28, wherein a cutting depth of the nonmetallic substrate is controlled to perform one-layer cutting for cutting either the upper or lower plate of the bonded panel.

30. The method of claim 28, wherein a cutting depth of the nonmetallic substrate is controlled to perform two-layer cutting for cutting both of the upper and lower plates of the bonded panel simultaneously.
